(19) United States
(12) Patent Application Publication
(10) Pub. No.: US 2026/0277745 A1
(43) Pub. Date: Sep. 17, 2026

(54) SYSTEM AND METHOD FOR GENERATING CONSISTENT BACKUPS USING MULTI-SNAPSHOT ANALYSIS IN VIRTUALIZED COMPUTING ENVIRONMENTS

(71) Applicant: Eon IO, Ltd., Tel Aviv (IL)

(72) Inventors: Assaf NATANZON, Tel Aviv (IL); Ron KIMCHI, Tel Aviv (IL); Dmitry KUZNETSOV, Tel Aviv Yafo (IL); Ilya SURDIN, Ramat Gan (IL); Daniel GOLDENSTEIN, Tel Aviv (IL)

(73) Assignee: Eon IO, Ltd., Tel Aviv (IL)

(21) Appl. No.: 19/076,479

(22) Filed: Mar. 11, 2025

(51) Int. Cl. G06F 11/14

(52) U.S. Cl. CPC G06F 11/1435; G06F 11/1448; G06F 11/1461

(57) ABSTRACT

A system and method for generating a backup of a file system are provided. The method includes capturing a plurality of snapshots of the file system at predetermined time intervals and in sequence without freezing operation of the file system, wherein the file system supports a workload that is deployed in a cloud environment; verifying each of the plurality of snapshots to determine whether the snapshot is valid or corrupted; selecting a valid snapshot for backup of the file system in response to determining that at least one snapshot is valid; initiating a repair process for snapshots determined to be corrupted in response to determining that no snapshot is valid; and designating the repaired snapshot as valid in response to successfully repairing at least one corrupted snapshot.

### TECHNICAL FIELD

The present disclosure relates generally to digital backup and restoration, and more particularly to systems and methods for generating consistent backups using multi-snapshot analysis in virtualized computing environments without requiring system-freezing operations.

### BACKGROUND

Digital backup and restoration are essential for preserving data integrity and ensuring continuous system operation in virtualized computing environments. Traditional backup methods typically involve creating snapshots of file systems or virtual machines to capture a system's state at a particular moment. However, these methods often struggle to achieve true consistency, especially when dealing with file systems or applications that are actively processing data.

For example, file systems such as XFS require special handling to ensure that a snapshot represents a consistent state. Conventional approaches, such as taking an EBS snapshot without pausing system operations (i.e., without using xfs_freeze), may capture data while write operations are still in progress. This situation can result in snapshots that are inconsistent or even corrupted, potentially leading to data loss or complications during restoration.

Even when measures are taken to ensure consistency, such as temporarily freezing the file system, these techniques introduce interruptions that are undesirable in environments requiring continuous availability. Moreover, similar challenges are encountered with application-level data; for instance, databases that are processing transactions may not be fully captured by a single snapshot, complicating the recovery process further.

Some environments attempt to mitigate such inconsistencies by employing freeze commands (e.g., xfs_freeze —f/mount/point), alternative backup utilities (e.g., xfsdump/xfsrestore), or kernel-level patches addressing XFS bugs. While these approaches can produce cleaner snapshots, they often entail downtime and do not always guard against mismatched instance types or unexpected behaviors in services like AWS EBS. Consequently, even these solutions may fail to ensure a fully consistent backup in the face of active write operations or underlying system variations.

Existing techniques that rely on post-capture repair procedures may mitigate some of these issues, but such methods can be time-consuming and do not always guarantee the integrity of the backup.

Therefore, it would be advantageous to provide a solution that overcomes the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include capturing a plurality of snapshots of the file system at predetermined time intervals and in sequence without freezing operation of the file system, where the file system supports a workload that is deployed in a cloud environment. The method may also include verifying each of the plurality of snapshots to determine whether the snapshot is valid or corrupted. The method may furthermore include selecting a valid snapshot for backup of the file system in response to determining that at least one snapshot is valid. The method may in addition include initiating a repair process for snapshots determined to be corrupted in response to determining that no snapshot is valid. The method may moreover include designating the repaired snapshot as valid in response to successfully repairing at least one corrupted snapshot. Other embodiments of this aspect include corresponding computer systems, apparatus, and computer programs recorded on one or more computer storage devices, each configured to perform the actions of the methods.

Implementations may include one or more of the following features. The method where verifying each of the plurality of snapshots further may include: mounting each snapshot in a validation environment; and performing at least one integrity check selected from the group having of a file system check and a database-level may include check. The method where capturing multiple snapshots in sequence may further include: requesting each snapshot from a snapshot service application programming interface. The method where initiating the repair process further may include: transferring each corrupted snapshot to a dedicated repair environment and applying a repair utility to address any file system or application-level it may include. The method may include, in response to determining that the repair utility has succeeded, generating a backup image of the repaired snapshot as a final backup image. The method where the workload is implemented as any of: a virtual machine, a container, and a serverless function, each capable of hosting one or more applications actively processing data managed by the file system. The method where designating the repaired snapshot as a valid snapshot includes processing a subsequent integrity check to confirm that the snapshot is no longer corrupted. The method may include, in response to detecting that the repair fails for all corrupted snapshots, capturing at least one additional snapshot or reverting to an earlier backup. Implementations of the described techniques may include hardware, a method or process, or a computer tangible medium.

In one general aspect, non-transitory computer-readable medium may include one or more instructions that, when executed by one or more processors of a device, cause the device to: capture a plurality of snapshots of the file system at predetermined time intervals and in sequence without freezing operation of the file system, where the file system supports a workload that is deployed in a cloud environment; verify each of the plurality of snapshots to determine whether the snapshot is valid or corrupted; select a valid snapshot for backup of the file system in response to determining that at least one snapshot is valid; initiate a repair process for snapshots determined to be corrupted in response to determining that no snapshot is valid; and designate the repaired snapshot as valid in response to successfully repairing at least one corrupted snapshot. Other embodiments of this aspect include corresponding computer systems, apparatus, and computer programs recorded on one or more computer storage devices, each configured to perform the actions of the methods.

In one general aspect, the system may include one or more processors configured to: capture a plurality of snapshots of the file system at predetermined time intervals and in sequence without freezing operation of the file system, where the file system supports a workload that is deployed in a cloud environment; verify each of the plurality of snapshots to determine whether the snapshot is valid or corrupted; select a valid snapshot for backup of the file system in response to determining that at least one snapshot is valid; initiate a repair process for snapshots determined to be corrupted in response to determining that no snapshot is valid; and designate the repaired snapshot as valid in response to successfully repairing at least one corrupted snapshot. Other embodiments of this aspect include corresponding computer systems, apparatus, and computer programs recorded on one or more computer storage devices, each configured to perform the actions of the methods.

Implementations may include one or more of the following features. The system where the one or more processors, when verifying each of the plurality of snapshots, are configured to: mount each snapshot in a validation environment; and perform at least one integrity check selected from the group having of a file system check and a database-level may include check. The system where the one or more processors, when capturing multiple snapshots in sequence, are configured to: request each snapshot from a snapshot service application programming interface. The system where the one or more processors, when initiating the repair process, are configured to: transfer each corrupted snapshot to a dedicated repair environment; and apply a repair utility to address any file system or application-level it may include. The system where the one or more processors are further configured to: in response to determining that the repair utility has succeeded, generating a backup image of the repaired snapshot as a final backup image. The system where the workload is implemented as any of: a virtual machine, a container, and a serverless function, each capable of hosting one or more applications actively processing data managed by the file system. The system where designating the repaired snapshot as a valid snapshot includes processing a subsequent integrity check to confirm that the snapshot is no longer corrupted. The system where the one or more processors are further configured to: in response to detecting that the repair fails for all corrupted snapshots, capturing at least one additional snapshot or reverting to an earlier backup. Implementations of the described techniques may include hardware, a method or process, or a computer tangible medium.

Embodiments of the present disclosure may be provided as a network of communicating devices (i.e. a “computerized network”). Embodiments of the invention may also be provided as a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is a network diagram illustrating a backup system that captures and stores backup snapshots in accordance with an embodiment of the present disclosure.

FIG. 2 is a flowchart illustrating a method for capturing multiple snapshots and verifying their integrity in accordance with an embodiment of the present disclosure.

FIG. 3 is a flowchart illustrating a method for repairing corrupted snapshots and generating a fixed backup in accordance with an embodiment of the present disclosure.

FIG. 4 is a block diagram illustrating a backup system architecture in accordance with an embodiment of the present disclosure.

### DETAILED DESCRIPTION

It is important to note that the embodiments disclosed herein are examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

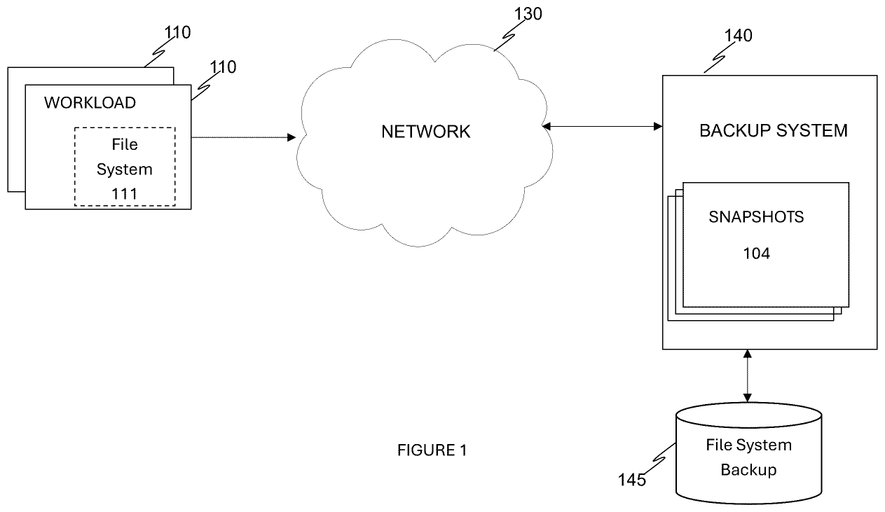

FIG. 1 is a network diagram illustrating a backup system 140 that captures and stores backup snapshots 104 in accordance with an embodiment of the present disclosure. FIG. 1 illustrates an example environment in which a workload 110 communicates over a network 130 with a backup system 140. The backup system 140 captures and stores backup snapshots 104 of a file system 111 of the workload 110 without issuing freeze commands or halting normal operations. Each snapshot is taken within a relatively short interval, minimizing reliance on a single, potentially corrupted snapshot.

In certain embodiments, workload 110 is a virtual machine, physical server, container platform, or serverless function. The workload 110 can host a file system, such as, but not limited to, a journaling file system (XFS), ext4, NFTS, or other types of file systems that typically handle continuous write operations. For platforms that conventionally call for freeze/unfreeze commands (such as xfs_freeze), the approach illustrated in FIG. 1 avoids these commands by generating multiple sequential snapshots. If any snapshot appears consistent, such a consistent snapshot can be promoted to a final backup; if multiple snapshots are corrupted, the backup system 140 may attempt repairs or recapture new snapshots.

The network 130 provides connectivity between the workload 110 and the backup system 140. In some configurations, this may be a local area network or a wide area network, including cloud-based virtual private clouds (VPCs) or on-premises data center fabrics. Through network 130, snapshots 104 can be transferred to the backup system 140 or to a dedicated backup account or secondary environment where verification or repair may be processed.

The backup system 140 orchestrates the multi-snapshot process, initiating snapshot requests, receiving or retrieving snapshot data, and performing integrity checks. In some embodiments, the system invokes a snapshot service application programming interface (API) to request point-in-time images of the file system. The snapshot service API may be provided by a local volume manager (e.g., LVM), a remote/cloud-based platform (e.g., AWS EBS, Azure Managed Disks), or any other equivalent snapshot mechanism. This programmatic interface allows the system to capture multiple sequential snapshots without requiring direct freeze operations on the file system, thereby facilitating the freeze-free backup approach. Because no file system freeze is required, the backup system 140 may capture multiple snapshots 104 in rapid succession (e.g., within seconds or minutes), ensuring that at least one snapshot is likely to be consistent. If a snapshot is found to be corrupt, the backup system 140 can discard it, attempt a repair, or proceed to the next snapshot.

The set of snapshots 104 represents the captured images or data sets forming the basis of the final system backup 145. The snapshots 104 can be retained locally, in another region, or in an entirely different account for isolation. In some embodiments, one or more snapshots 104 are transferred to a secondary or “backup” account, where a separate virtual machine can process, verify, or archive the data. This ensures that production operations remain unaffected while the backup system 140 analyzes each snapshot for corruption or repairs inconsistencies if needed. By maintaining multiple snapshots 104 rather than a single freeze-based capture, the system avoids reliance on any one snapshot's integrity.

If all snapshots 104 in a cycle appear corrupted, some embodiments allow for an automated repair step. The snapshot data may be mounted or uploaded to a specialized repair environment, such as a machine or VM in the same or a different account, where file system tools (e.g., xfs_repair) are used to correct snapshot inconsistencies. In one embodiment, the repair environment is a separate machine, virtual instance, or container that has access to repair utilities (e.g., xfs_repair for XFS file systems, vendor-specific tools for a given database).

In some embodiments, this repair environment is hosted in a dedicated backup account or isolated infrastructure, thus preventing any potential interference with production workloads or other snapshots. Moving the snapshot away from the production environment allows the repair process to proceed without impacting ongoing I/O or risking further corruption in the primary system.

If the repair succeeds, the system produces a “fixed” backup, potentially replacing the original corrupted snapshot. Otherwise, additional snapshots can be taken, or the system can revert to older backups. This process avoids freezing the workload 110 and reduces downtime by relying on a short-interval, multi-snapshot approach.

Although FIG. 1 illustrates an example involving a journaling file system such as XFS and a snapshot service such as AWS Elastic Block Store (EBS), the techniques disclosed herein are not limited to that particular combination. In other embodiments, the same multi-snapshot approach can be applied to alternative platforms, including Azure, Google Cloud Platform (GCP), or local logical volume managers (LVM). Rather than relying on a conventional freeze/unfreeze sequence, the backup system 140 adopts a statistical approach wherein multiple snapshots are captured over a brief timeframe. If at least one snapshot is valid or can be rendered valid through a repair process, it is designated as the final backup, thereby accommodating environments with numerous virtual instances or continuous-write workloads.

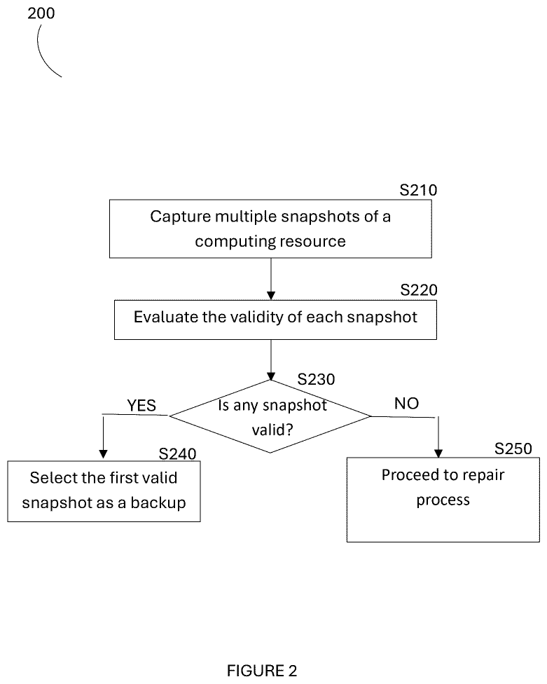

FIG. 2 is a flowchart illustrating a method 200 for capturing multiple snapshots and verifying their integrity, in accordance with an embodiment of the present disclosure.

At S210, multiple snapshots are captured in quick succession. The computing resource may be a virtual machine, a container, a serverless function, or another platform on which a file system or database is running. In one embodiment, issuing these snapshot commands closely together reduces the reliance on any single snapshot for consistency. This approach does not require a freeze operation (e.g., using xfs_freeze in an xfs), thereby avoiding disruptions to the computing resource's ongoing operations. In one embodiment, both the number of snapshots and the time interval for capturing these snapshots are predetermined. For instance, there can be a total of 10 snapshots, with a 10-second interval between each one. The number of snapshots and/or the time interval may be determined based on the application.

At S220, each snapshot is evaluated to determine whether it is corrupted. In an embodiment, the snapshot is mounted, or otherwise made accessible in a validation context. When a snapshot is accessible, a series of checks are executed. Examples for such checks include file system integrity tests (e.g., xfs_repair —n) or, for database-oriented snapshots, an application-specific integrity check. Each snapshot is marked either valid or corrupted, depending on whether any inconsistencies are detected. This multi-check procedure increases the likelihood that at least one snapshot is fully consistent even if others prove unusable.

At S230, it is determined if at least one snapshot has been flagged valid from the checks performed in step S220. If at least one snapshot is found to be consistent, the process can move on to step S240; otherwise, if all snapshots are marked corrupted, the method transitions to a repair phase where a repair process is performed. In some embodiments, it is determined whether any snapshot satisfies a predetermined threshold. The predetermined threshold may be the minimum acceptable level of consistency or integrity, e.g. requiring that the snapshot pass a file system check (e.g., xfs_repair —n) without detecting errors.

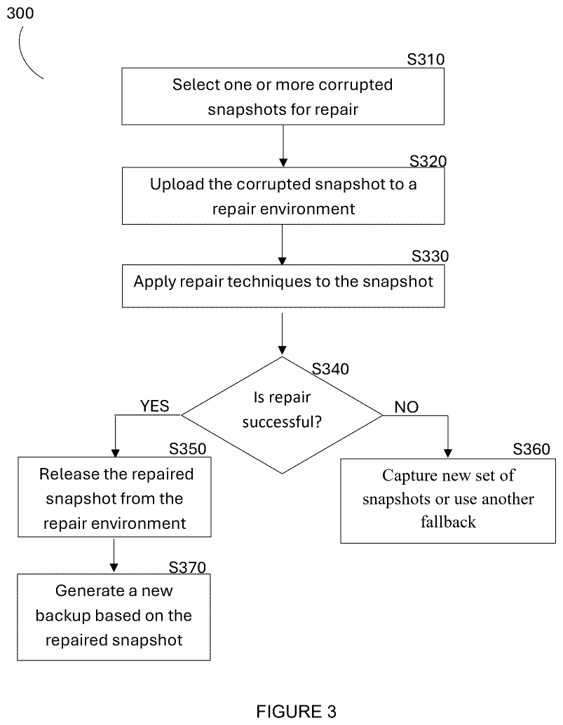

If all snapshots fail to meet this threshold, the process advances to additional remedial measures, performed during the repair phase (discussed in FIG. 3).

At S240, when at least one valid snapshot is found, a valid snapshot is selected for the backup process. In certain implementations, the selected snapshot may be the first valid snapshot encountered, thereby expediting the creation of a final backup. A snapshot that passes all integrity checks is used as a backup of the file system. It should be noted that such a backup can be stored or replicated as a consistent image without further need for freeze-based operations.

At S250, if no valid snapshot is identified (i.e., if every snapshot is flagged as corrupted), a repair process is executed. Rather than discarding the entire set of snapshots, the system attempts to salvage one or more by applying known repair techniques, as further explained in FIG. 3.

FIG. 3 is a flowchart illustrating a method 300 for repairing corrupted snapshots and generating a fixed backup, in accordance with an embodiment of the present disclosure.

At S310, each corrupted snapshot from the group, flagged in FIG. 3 for possible repair, is identified and selected. Corruption may result from, for example, incomplete writes during snapshot creation, file system journaling issues, or inconsistencies in a database-level dump.

At S320, each corrupted snapshot is mounted to a repair environment. In one embodiment, the repair environment is a separate machine, virtual instance, or container that has access to repair utilities (e.g., xfs_repair for XFS file systems, vendor-specific tools for a given database). In some embodiments, this repair environment is hosted in a dedicated backup account or isolated infrastructure, thus preventing any potential interference with production workloads or other snapshots. By moving the snapshot away from the production environment, the repair process can proceed without impacting ongoing I/O or risking further corruption in the primary system.

At S330, one or more repair techniques are applied to the corrupted snapshot. The exact technique depends on the type of data within the snapshot-for instance, a file system-level repair command may rebuild metadata structures, while a database repair tool might address inconsistencies in tables or indexes. If some issues can be fixed automatically, the snapshot may become fully functional following this procedure, removing the need to capture entirely new snapshots.

At S340, it is determined whether the repair was successful by rechecking the snapshot for integrity. This may involve the same or similar checks performed in step S220 of FIG. 2. If the snapshot is now validated, the method proceeds to S350; otherwise, the method moves to S360 or another fallback approach. In some embodiments, the fallback approach includes capturing a new round of snapshots (such as the process taken in FIG. 2) to replace the corrupted set or reverting to an earlier backup version if available. Verifying the snapshot upon completion of the repair confirms its suitability for subsequent backup or restoration operations.

At S350, the repaired snapshot is released from the repair environment, indicating it has passed the final checks and is ready for backup usage. S450 may also include unmounting the snapshot or updating its status to reflect that it is no longer corrupted.

At S370, a fixed backup is generated based on the repaired snapshot. In one embodiment, the repaired snapshot itself is designated as a final backup image upon confirmation of consistency. In another embodiment, a fresh copy is produced or archived that reflects all corrected data from the repaired snapshot. Some embodiments also retain a copy of the pre-repair snapshot for historical or reference purposes, noting that repairs typically modify only a small number of blocks. By storing both versions, the system can later compare the original and repaired states to identify which blocks changed during the repair process. In either scenario, the resulting backup is considered suitable for any subsequent restoration procedures.

At S360, if the repair is not successful (e.g., integrity checks still indicate corruption), additional snapshots may be captured or employed as a further fallback.

In one embodiment, the backup system attempts to capture new snapshots of the same resource, thereby returning to the approach described in FIG. 2 in order to obtain at least one consistent snapshot. In another embodiment, the system may revert to a prior backup set if one exists, attempt more advanced repair utilities, or prompt an administrative notification. By leveraging one or more of these fallback strategies, the system maximizes the likelihood of securing a functional backup without imposing a freeze on the underlying resource.

In some embodiments, snapshots and repairs may leverage vendor-provided tools rather than any custom implementation. For example, if the underlying file system is XFS, one approach to verifying snapshot integrity is to execute xfs_repair —n/dev/xvdf (dry-run mode) after restoration. If this check reveals corruption, the snapshot can be repaired by running xfs_repair/dev/xvdf. Similarly, if the application is MongoDB, the backup system may employ MongoDB-specific repair utilities provided by the vendor.

The disclosed embodiments have been described with reference to a specific implementation of the XFS journaling file system. However, these embodiments are not limited to XFS and may be applicable to other types of file systems that are supported by workloads.

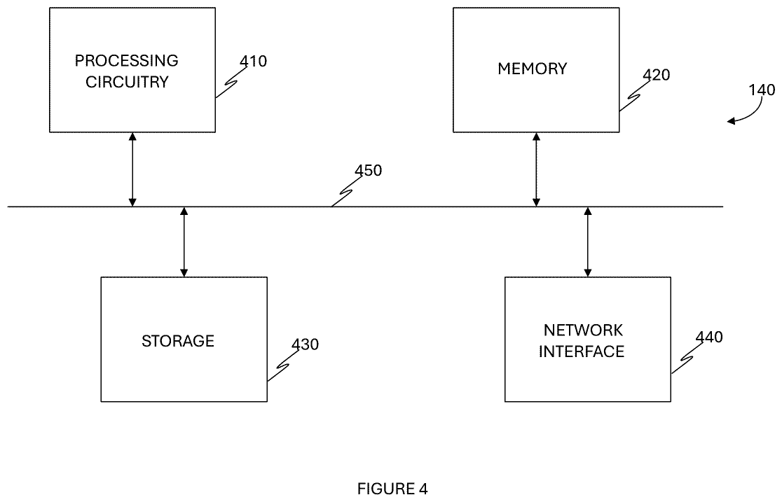

FIG. 4 is a block diagram illustrating a backup system architecture in accordance with an embodiment of the present disclosure. The backup system 140 includes, according to an embodiment, a processing circuitry 410 coupled to a memory 420, a storage 430, and a network interface 440. In an embodiment, the components of the backup system 140 are communicatively connected via a bus 450. In certain embodiments, the backup system 140 is further configured to orchestrate multiple freeze-free snapshots, verify snapshot integrity, and initiate repair operations for corrupted snapshots.

In certain embodiments, the processing circuitry 410 is realized as one or more hardware logic components and circuits. For example, according to an embodiment, illustrative types of hardware logic components include field programmable gate arrays (FPGAs), application-specific integrated circuits (ASICs), application-specific standard products (ASSPs), system-on-a-chip systems (SOCs), graphics processing units (GPUs), tensor processing units (TPUs), Artificial Intelligence (Al) accelerators, general-purpose microprocessors, microcontrollers, digital signal processors (DSPs), and the like, or any other hardware logic components that are configured to perform calculations or other manipulations of information.

In an embodiment, the memory 420 is a volatile memory (e.g., random access memory, etc.), a non-volatile memory (e.g., read-only memory, flash memory, etc.), a combination thereof, and the like. In some embodiments, the memory 420 is an on-chip memory, an off-chip memory, a combination thereof, and the like. In certain embodiments, the memory 420 is a scratch-pad memory for the processing circuitry 410. In one embodiment, the memory 420 stores program instructions enabling the backup system 140 to manage multiple snapshot captures, validate each snapshot, and repair any inconsistencies if needed.

In one configuration, software for implementing one or more embodiments disclosed herein is stored in the storage 430, in the memory 420, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 410, cause the processing circuitry 410 to perform the various processes described herein, in accordance with an embodiment.

In some embodiments, the storage 430 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 440 is configured to provide the backup system 140 with communication with, for example, the network 130, workload 110, file system backup 145, etc., according to an embodiment.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for generating a backup of a file system, the method comprising:
capturing a plurality of snapshots of the file system at predetermined time intervals and in sequence without freezing operation of the file system, wherein the file system supports a workload that is deployed in a cloud environment;
verifying each of the plurality of snapshots to determine whether the snapshot is valid or corrupted, wherein verifying each of the plurality of snapshots comprises mounting each snapshot, performing a file system check on each mounted snapshot, marking each snapshot as valid when the snapshot passes the file system check without detecting errors, and marking each snapshot as corrupted when the file system check detects any inconsistencies;
selecting one of the snapshots marked as valid for backup of the file system in response to determining that at least one snapshot is marked as valid;
initiating a repair process for snapshots determined to be corrupted in response to determining that no snapshot is valid; and
designating the repaired snapshot as valid in response to successfully repairing at least one corrupted snapshot.

2. The method of claim 1, wherein the file system check comprises a file system integrity test.

3. The method of claim 1, wherein capturing multiple snapshots in sequence further comprises: requesting each snapshot from a snapshot service application programming interface.

4. The method of claim 1, wherein initiating the repair process further comprises:
transferring each corrupted snapshot to a dedicated repair environment; and
applying a repair utility to address any file system or application-level inconsistencies.

5. The method of claim 4, further comprising, in response to determining that the repair utility has succeeded, generating a backup image of the repaired snapshot as a final backup image.

6. The method of claim 1, wherein the workload is implemented as any of: a virtual machine, a container, and a serverless function, each capable of hosting one or more applications actively processing data managed by the file system.

7. The method of claim 1, wherein designating the repaired snapshot as a valid snapshot includes processing a subsequent integrity check to confirm that the snapshot is no longer corrupted.

8. The method of claim 1, further comprising, in response to detecting that the repair fails for all corrupted snapshots, capturing at least one additional snapshot or reverting to an earlier backup.

9. A non-transitory computer-readable medium storing a set of instructions for generating a backup of a file system, the set of instructions comprising:
one or more instructions that, when executed by one or more processors of a device, cause the device to:
capture a plurality of snapshots of the file system at predetermined time intervals and in sequence without freezing operation of the file system, wherein the file system supports a workload that is deployed in a cloud environment;
verify each of the plurality of snapshots to determine whether the snapshot is valid or corrupted, wherein verifying each of the plurality of snapshots comprises mounting each snapshot, performing a file system check on each mounted snapshot, marking each snapshot as valid when the snapshot passes the file system check without detecting errors, and marking each snapshot as corrupted when the file system check detects any inconsistencies;
select one of the snapshots marked as valid for backup of the file system in response to determining that at least one snapshot is marked as valid;
initiate a repair process for snapshots determined to be corrupted in response to determining that no snapshot is valid; and
designate the repaired snapshot as valid in response to successfully repairing at least one corrupted snapshot.

10. A system for generating a backup of a file system comprising:
one or more processors configured to:
capture a plurality of snapshots of the file system at predetermined time intervals and in sequence without freezing operation of the file system, wherein the file system supports a workload that is deployed in a cloud environment;
verify each of the plurality of snapshots to determine whether the snapshot is valid or corrupted, wherein, to verify each of the plurality of snapshots, the one or more processors are configured to mount each snapshot, perform a file system check on each mounted snapshot, mark each snapshot as valid when the snapshot passes the file system check without detecting errors, and mark each snapshot as corrupted when the file system check detects any inconsistencies;
select one of the snapshots marked as valid for backup of the file system in response to determining that at least one snapshot is marked as valid;
initiate a repair process for snapshots determined to be corrupted in response to determining that no snapshot is valid; and
designate the repaired snapshot as valid in response to successfully repairing at least one corrupted snapshot.

11. The system of claim 10, wherein the file system check comprises a file system integrity test.

12. The system of claim 10, wherein the one or more processors, when capturing multiple snapshots in sequence, are configured to:
request each snapshot from a snapshot service application programming interface.

13. The system of claim 10, wherein the one or more processors, when initiating the repair process, are configured to:
transfer each corrupted snapshot to a dedicated repair environment; and
apply a repair utility to address any file system or application-level inconsistencies.

14. The system of claim 13, wherein the one or more processors are further configured to:
generate a backup image of the repaired snapshot as a final backup image in response to determining that the repair utility has succeeded.

15. The system of claim 10, wherein the workload is implemented as any of:
a virtual machine, a container, and a serverless function, each capable of hosting one or more applications actively processing data managed by the file system.

16. The system of claim 10, wherein designating the repaired snapshot as a valid snapshot includes processing a subsequent integrity check to confirm that the snapshot is no longer corrupted.

17. The system of claim 10, wherein the one or more processors are further configured to:
capture at least one additional snapshot or revert to an earlier backup in response to detecting that the repair fails for all corrupted snapshots.
